(19) United States
(12) Patent Application Publication
(10) Pub. No.: US 2009/0205001 A1
(43) Pub. Date: Aug. 13, 2009

(54) Intelligent Disaster Recovery for Digital Cinema Multiplex Theaters

(75) Inventors: John Robert Naylor, Lake Oswego, OR (US); James Edward Pearce, Portland, OR (US); Mark Hillebrandt, Portland, OR (US)

Correspondence Address: Thomson Licensing LLC, P.O. Box 5312, Two Independence Way, PRINCETON, NJ, 08543-5312, US

(73) Assignee: Thomson Licensing, Boulogne-Billancourt (FR)

(21) Appl. No.: 11/989,142

(22) PCT Filed: Dec. 9, 2005
(86) PCT No.: PCT/US2005/044552

§ 371 Date: Feb. 27, 2009

Related U.S. Application Data
(60) Provisional application No. 60/703,936, filed on Jul. 29, 2005.

(51) Int. Cl. H04N 7/18

(52) U.S. Cl. 725/82

(57) ABSTRACT

A system for a digital multiplex theater having a plurality of auditoriums includes a central server, playout servers, and an intelligent selection module. The central server has a local storage device configured to store digital cinema movies. The playout servers are each configured to playout the movies at a respective auditorium and have a respective local storage device configured to redundantly store the movies. The intelligent selection module selects a source for playing out, in an alternate auditorium in place of a scheduled auditorium, from a respective playout server in place of a scheduled playout server, a portion of a movie interrupted by a malfunction occurring at the scheduled auditorium. The selection is made from among any of the storage devices, and is based upon at least a current playing out ability of the scheduled playout server, and a playout schedule of the storage device at the alternate auditorium.

### CROSS-REFERENCE TO RELATED APPLICATIONS

This application claims the benefit of U.S. Provisional Application Ser. No. 60/703,936, filed Jul. 29, 2005, which is incorporated by reference herein in its entirety.

### FIELD OF THE INVENTION

The present invention relates generally to digital movie playback and, more particularly, to intelligent disaster recovery for digital cinema multiplex theaters.

### BACKGROUND OF THE INVENTION

Movie distribution and exhibition is currently in transition from using film as the distribution and exhibition medium to using digital media that are distributed as computer files and exhibited using digital cinema playout servers, digital projectors and audio processors.

Some types of equipment failure that can occur during the playing back of a digital cinema movie can only be remedied by moving the audience to an alternate auditorium. For this solution to be effective, the movie that was playing in the failed auditorium must also be moved to the alternate auditorium. For example, at present, with analog equipment, recovery can be achieved by moving the distribution print to the alternate auditorium, or threading the film from the failed auditorium to the alternate.

Accordingly, it would be desirable and highly advantageous to have an intelligent disaster recovery system for digital cinema multiplex theaters that overcomes the above-identified problems of the prior art.

### SUMMARY OF THE INVENTION

These and other drawbacks and disadvantages of the prior art are addressed by the present invention, which is directed to intelligent disaster recovery for digital cinema multiplex theaters.

According to an aspect of the present invention, there is provided a playout and malfunction recovery system for a digital cinema multiplex theater having a plurality of auditoriums. The system includes a central storage server, a plurality of playout servers, and an intelligent selection module. The central storage server has a local central storage device configured to store digital cinema movies. The plurality of playout servers, in signal communication with the central storage server, are each configured to playout the digital cinema movies at a respective one of the plurality of auditoriums and have a respective local storage device configured to redundantly store the digital cinema movies. The intelligent selection module is configured to select a source for playing out, in an alternate one of the plurality of auditoriums in place of a scheduled one of the plurality of auditoriums, from a respective one of the plurality of playout servers in place of a scheduled one of the plurality of playout servers, a portion of a digital cinema movie interrupted by a malfunction occurring at the scheduled one of the plurality of auditoriums. The selection is made from among the local central storage device and the respective local storage device of each of the plurality of playout servers, and is based upon at least a current playing out ability of the scheduled one of the plurality of playout servers, and a playout schedule of the respective local storage device of the respective one of the plurality of playout servers at the alternate one of the plurality of auditoriums.

According to another aspect of the present invention, there is provided a method for malfunction recovery in a digital cinema multiplex theater having a plurality of auditoriums. The method includes the step of providing a network that includes a plurality of playout servers connected in signal communication with a central storage server. Each of the plurality of playout servers and the central storage server have a respective local storage device coupled thereto for redundantly storing digital cinema movies. Each of the plurality of playout servers are for playing out scheduled ones of the digital cinema movies to a respective local one of the plurality of auditoriums. The method further includes the step of selecting a source for playing out, in an alternate one of the plurality of auditoriums in place of a scheduled one of the plurality of auditoriums, from a respective one of the plurality of playout servers in place of a scheduled one of the plurality of playout servers, a portion of a digital cinema movie interrupted by a malfunction occurring at the scheduled one of the plurality of auditoriums. The selection is made from among the local central storage device and the respective local storage device of each of the plurality of playout servers, and is based upon at least a current playing out ability of the scheduled one of the plurality of playout servers, and a playout schedule of the respective local storage device of the respective one of the plurality of playout servers at the alternate one of the plurality of auditoriums.

According to yet another aspect of the present invention, there is provided a playout and malfunction recovery system for a digital cinema multiplex theater having a plurality of auditoriums. The system includes a plurality of playout servers and an intelligent selection module. The plurality of playout servers are each configured to playout digital cinema movies at a respective one of the plurality of auditoriums and have a respective local storage device configured to store the digital cinema movies. The intelligent selection module is configured to select a source for playing out, in an alternate one of the plurality of auditoriums in place of a scheduled one of the plurality of auditoriums, from a respective one of the plurality of playout servers in place of a scheduled one of the plurality of playout servers, a portion of a digital cinema movie interrupted by a malfunction occurring at the scheduled one of the plurality of auditoriums. The selection is made from among the respective local storage device of each of the plurality of playout servers, and is based upon at least a current playing out ability of the scheduled one of the plurality of playout servers, and a playout schedule of the respective local storage device of the respective one of the plurality of playout servers at the alternate one of the plurality of auditoriums.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 is a block diagram illustrating an exemplary digital cinema multiplex system to which the present invention may be applied in accordance with an illustrative embodiment of the present invention; and

FIG. 2 is a flow diagram illustrating an exemplary method for disaster recovery for digital cinema multiplex theaters in accordance with the principles of the present invention.

### DETAILED DESCRIPTION

The present invention is directed to intelligent disaster recovery for digital cinema multiplex theaters. The present invention permits a digital cinema multiplex theatre to recover from one or multiple equipment failures by allowing the disaster affected movie to be played out on a different screen within the multiplex in a timely fashion. It is to be appreciated that as used herein, the term “disaster” refers to any malfunction and particularly those malfunctions that may result in the playing out of an interrupted movie in a different auditorium that that originally scheduled.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

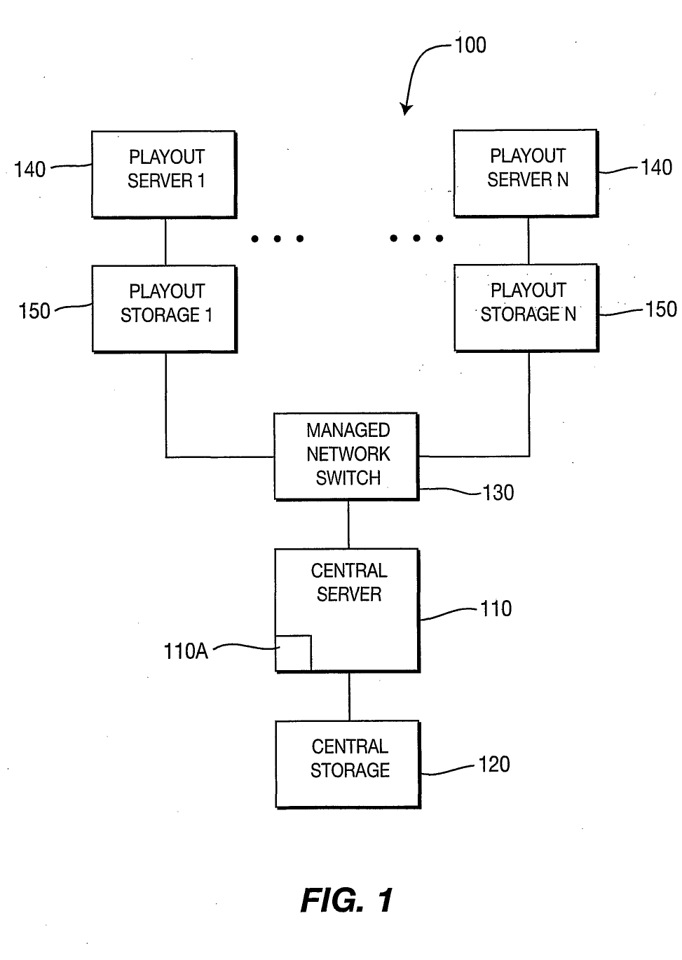

Turning to FIG. 1, an exemplary digital cinema multiplex system to which the present invention may be applied is indicated generally by the reference numeral 100. The digital cinema multiplex system 100 includes: a central storage server 110; a central storage device 120; a managed network switch 130; a plurality of playout servers 140; and a plurality of playout storage devices 150.

The central storage server 110 loads digital cinema movies into the system digital cinema multiplex system 100. Moreover, the central storage server 110 is used to assign particular movies to auditoriums, schedule playout times for each auditorium, and to communicate with the movie distributor to obtain the secret keys that are necessary to decrypt the digital cinema content files. The central storage server 110 includes an intelligent selection module 110A, whose functionality is described in further detail herein below.

The central storage device 120 is disposed locally with respect to the central storage server 110. The central storage device 120 preferably includes enough capacity to store a plurality of movies.

The managed network switch 130 permits high speed, peer-peer communications between all devices to which it is connected.

The plurality of playout servers 140 converts the media tracks into useable signals by decrypting and decompressing the media tracks as necessary.

The plurality of playout storage devices 150 is configured such that each of the plurality of playout storage devices 150 is associated with a respective one of the plurality of playout servers 140. Preferably, each of the plurality of playout storage devices includes enough capacity to store a plurality of movies.

It is to be appreciated that the present invention is not limited to the specific configuration of the digital cinema multiplex system 100 shown in FIG. 1 and, thus, given the teachings of the present invention provided herein, this and other configurations for a digital cinema multiplex system in accordance with the principles of the present invention may be readily contemplated by those of ordinary skill in this and related arts, while maintaining the scope of the present invention. For example, in other embodiments, the central storage device 120 may be included within, and be part of, the central storage server 110, and each of the playout storage devices 130 may be included within, and be part of, a respective one of the playout servers 140. Moreover, the intelligent selection module 110 may be included in any of the plurality of playout servers 140 (and/or sub-elements thereof and/or associated elements therewith), in addition to, or in place of, being included in the central storage server 110 (and/or sub-elements thereof and/or associated elements therewith). Of course, as noted above, other variations may also be employed in accordance with the principles of the present invention.

It is to be further appreciated that the digital cinema movies employed with respect to the present invention may be compliant with the Digital Cinema Initiatives, LLC, “Digital Cinema Specification V1.0”, Hollywood, Calif., www.dcimovies.com, Jul. 20, 2005 (hereinafter referred to as the “DCI specification”). In accordance with the DCI specification, digital cinema movies have the following structure: (a) each complete movie is composed as a sequence of “reels”; and each reel includes several media tracks (e.g., one for pictures, up to 16 for audio, others for subtitles captions, and so forth). Further in accordance with the DCI Specification, the media tracks are encrypted, and the picture track is both compressed and encrypted. Moreover, it is to be appreciated that while embodiments described herein are so described with respect to the DCI specification, the present invention may be readily implemented with respect to digital cinema movies that are not in compliance with the DCl specification while maintaining the scope of the present invention.

Embodiments are disclosed herein relating to two illustrative operating patterns that may be combined, as described in further detail herein below. The two patterns are referred to herein as “preparing for failure” and “recovering from failure”. Of course, given the teachings of the present invention provided herein, one of ordinary skill in this and related arts will contemplate these and other patterns and variations thereof that may be used in accordance with the principles of the present invention while maintaining the scope thereof.

A description will now be given regarding “preparing for failure” in accordance with an exemplary embodiment of the present invention.

Preparing for failure is performed by the central storage server 110 which maintains an overview of all the movies that exist in the various storage pools (both the central storage device 120 and each of the plurality of playout storage devices 150) of system 100, and can copy, transfer and delete the movies. The central storage server 110 also maintains the playout schedule for each auditorium. The central storage server 120, using the information maintained therein or accessible there from, stages redundant copies of scheduled movies on appropriate stores within the system 100 so that a copy of every scheduled movie is accessible from each of the plurality of playout servers 140, either locally, from another playout server's playout storage, or from the central storage device 120. It is to be appreciated that, in other embodiments, the preceding functions described with respect to the central storage server 120 may be performed by one or more other servers in the system, in addition to or in place of the central storage server 120, while maintaining the scope of the present invention. Accordingly, it is to be further appreciated that the central storage server 120 may be omitted in some embodiments, while maintaining the scope of the present invention.

An example directed to a four screen multiplex showing the following movies listed in Table 1 will now be described in accordance with an illustrative embodiment.

TABLE 1

| Location | Central Store | Screen 1 | Screen 2 | Screen 3 | Screen 4 |
|---|---|---|---|---|---|
| Scheduled | None - Central | STAR WARS | STAR WARS | SHREK | MADAGASCAR |
| Movie | store isn't in | | | | ~ |
| | an auditorium. | | | | |
| Movies | STAR WARS | STAR WARS | STAR WARS | SHREK | MADAGASCAR |
| stored at | SHREK | SHREK | MADAGASCAR | STAR WARS | STAR WARS |
| this location | MADAGASCAR | | | | |

In the example, each scheduled movie has been copied to the playout server 140 at the auditorium in which it will be exhibited. Therefore, every playout server 140 has local access to the movie that it is supposed to be playing.

In addition, redundant copies of the movies have been distributed by the central storage server 110. For example, the central storage device 120 maintains a copy of all the movies being exhibited, and each of the plurality of playout storage devices 150 maintains a redundant copy of a movie that is scheduled for another auditorium within the multiplex.

Now consider a failure that disables one of the screens, say Screen 3 showing Shrek. If there is a large audience for this movie, the theater manager will want to avoid having to refund ticket money by moving the movies to an alternate screen, and the recovery system provides the ability to use any of the other three auditoriums.

Naturally, the theatre manager will want to select the alternate auditorium so as to minimize any revenue loss, some possible scenarios include, but are not limited to: meeting the demand for STAR WARS tickets with one auditorium; and STARS WARS is a sell out in both theaters, but hardly any MADAGASCAR tickets have been sold.

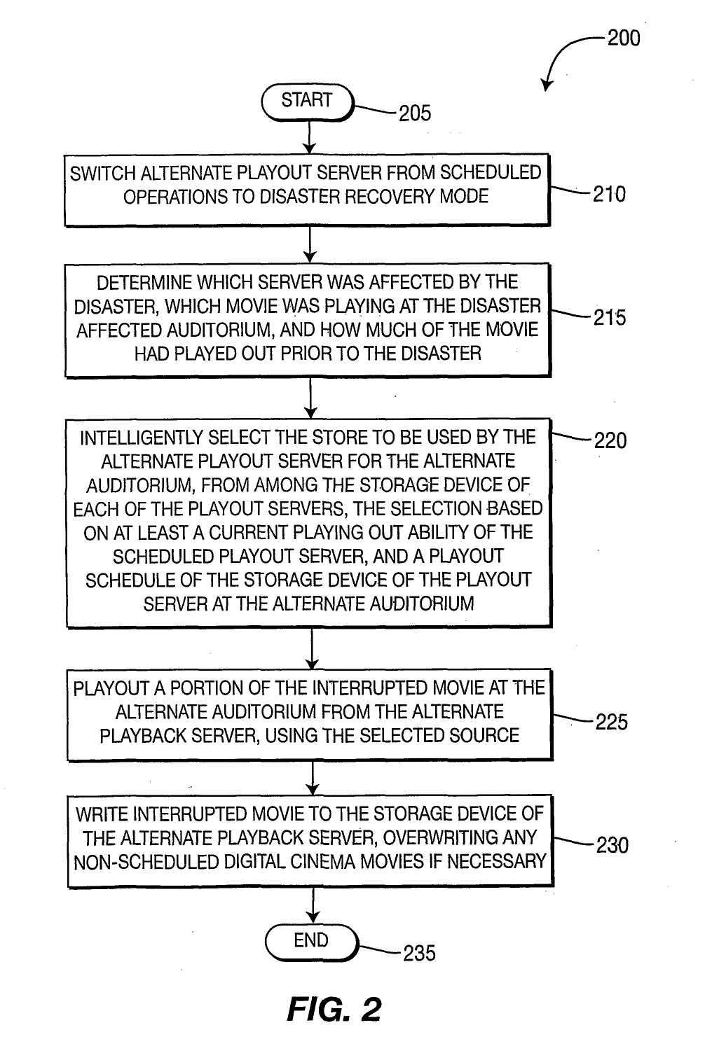

Once the manager has selected the alternate auditorium, the system 100 may be configured to support the following sequence described with respect to FIG. 2.

Turning to FIG. 2, a method for disaster recovery for digital cinema multiplex theaters is indicated generally by the reference numeral 200. As used herein, the phrase “scheduled auditorium” and synonyms thereof refer to the auditorium at which the disaster occurs and, hence, where a playout of a digital cinema movie is interrupted. Moreover, the phrase “alternate auditorium” and synonyms thereof refer to the auditorium in which playout of the interrupted digital cinema movies is to resume. Similarly, the “scheduled playout server” and synonyms thereof refer to the playout server at or servicing the scheduled auditorium, and the “alternate playout server” and synonyms thereof refer to the playout server at or servicing the alternate auditorium.

A start block 205 passes control to a function block 210. The function block 210 switches an alternate playout server 140 from scheduled operations to a “disaster recovery” mode, either at the central storage server 110 or at the playout server 140 in the alternate auditorium (as both can be supported if desired), and passes control to a function block 215. The switch may be made automatically by the system 100 based on a detection of a disaster by the system, and/or may be made in response to a user input. It is to be appreciated that the disaster may relate to a malfunction or otherwise undesirable condition of one or more of a display screen, a playout server, and a local storage device at the scheduled auditorium or an undesirable condition itself of the scheduled auditorium (e.g., foul smell, malfunctioning HVAC system, and so forth).

The function block 215 determines which playout server in the system has been affected by the disaster (i.e., identifies the scheduled playout server), which movie was playing at the disaster affected auditorium (i.e., identifies the interrupted digital cinema movie), and how much of the movie had been played out prior to the disaster, and passes control to a function block 220. It is to be appreciated that the determinations may be made automatically by the system 100 and/or may be based upon one or more user inputs. It is to be further appreciated that the function block 215 may perform the determination by making the appropriate requests of the central storage server 110, by making the same requests of the disaster affected server if it is still functional, and/or based upon one or more user inputs. Moreover, it is to be appreciated that at least some of the preceding determinations may have been made prior to the switching performed by the function block 210.

The function block 220 intelligently selects the store to be used by the alternate playout server for a playing back of a portion of the interrupted digital cinema movie at the alternate auditorium, and passes control to a function block 225. It is to be appreciated that the function block 220 performs the selection from among the storage device of the central storage server and/or the storage device of each of the playout servers. It is to be appreciated that the function block 220 performs the selection based upon at least a current playing out ability of the scheduled playout server, and a playout schedule of the storage device of the alternate playout server.

Thus, the function block 220 performs the intelligent selection from the following exemplary options: (a) local playout storage, since there happens to be a copy of the movie already there; (b) playout from the disaster-affected server's store; (c) playout from another playout server's store; and (d) playout from the central server's store. It is to be appreciated that option (b) is only available in cases where the disaster has not affected a server's ability to read and transmit data. It is to be further appreciated that option (c) is only presented if the playout server is not currently playing a movie, nor scheduled to play a movie before exhibition of the recovered movie will complete. This relates to the “intelligent” part.

In the cases of options 4b, 4c and 4d, remote playout of the interrupted digital cinema movie can happen within a short time (e.g., <15 minutes) because the system supports simultaneously reading—the movie tracks across the switched network, and playing (decrypt, decode). In case of option 4a, playout can be instantaneous because the digital cinema movie is already available in local storage.

The function block 225 plays out a portions of the interrupted movie (e.g., at a point several minutes prior to the point in the interrupted movie when the disaster occurred) at the alternate auditorium from the alternate playback server, using the source selected by function block 220, and passes control to a function block 230.

The function block 230, during remote playout at the alternate auditorium, commands the alternate playout server to write the interrupted movie to its local store, overwriting any non-scheduled movies if necessary to have the space to so do, and passes control to an end block 235. It is to be appreciated that function block 230 performs the writing to the local store so that the next playout of the recovered movie can be done from local storage and the network bandwidth is available to allow recovery from subsequent failures.

A description will now be given regarding some of the many attendant advantages/features of the present invention. One advantage/feature of the present invention is the ability to quickly and simply recover from an equipment failure at a single auditorium in a multiplex. Another advantage/feature of the present invention is that only Ix speed access is needed to any store for normal playout and disaster recovery playout. This means that lower cost components can be used for each store. Yet another advantage/feature of the present invention is that the recovery from a single failure is guaranteed. Moreover, another advantage/feature of the present invention is the ability, in most cases, to recover from multiple failures (e.g., two auditoriums suffer simultaneous equipment failures). Further, another advantage/feature of the present invention is that the selection of the most appropriate store from which to play the recovered movie is simple and foolproof since the system uses its knowledge of show times to avoid two playout servers trying to use the same playout store simultaneously.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A playout control system for a digital cinema theater, comprising:
a plurality of playout servers, configured to playout digital content to a plurality of facilities; and
a selector (110A) for selecting a source of digital content to supply content to at least one of the plurality of playout servers to allow alternative playout for digital content viewing for at least one of the plurality of facilities.

2. The system of claim 1, wherein the selector is further configured for selecting from among a local central storage device associated with a central storage server and a respective local storage device of each of the plurality of playout servers, and basing selections upon at least a current playing out ability of at least one of the plurality of playout servers, and a playout schedule of a respective local storage device of one of the playout servers at an alternate one of the plurality of facilities.

3. The system of claim 1, wherein the selector is configured to perform a selection so as to initially select a respective local storage device of a respective one of the plurality of playout servers at an alternate one of the plurality of facilities, when a playout schedule thereof is not affected thereby.

4. The system of claim 1, further comprising a central storage server for receiving digital content from a remote distribution source.

5. The system of claim 1, further comprising a central storage server for assigning a particular digital content to the plurality of facilities, and schedule playout times for each of the plurality of facilities.

6. The system of claim 1, wherein the plurality of playout servers is configured to decrypt and decompress digital content media tracks, and a central storage server is configured to receive and re-distribute keys from a remote movie distribution source, the keys for decrypting digital content.

7. The system of claim 1, further comprising a managed network switch, for enabling communication between a central storage server and the plurality of playout servers.

8. The system of claim 1, wherein each of the plurality of facilities comprises a respective display screen, and the selector selects a source in response to a malfunction relating to one of, the respective one of the plurality of playout servers, a respective local storage device, and the respective display screen, of a scheduled one of the plurality of facilities, and an undesirable condition itself of the scheduled facilities.

9. The system of claim 1, wherein the selector is configured to perform the selection so as to exclude a respective local storage device coupled to a scheduled one of the plurality of playout servers, when the respective local storage device coupled to the scheduled one of the plurality of playout servers is unable to play out interrupted digital content.

10. The system of claim 1, wherein the selector is configured to perform the selection so as to exclude a respective local storage device coupled to an alternate one of the plurality of playout servers, when the alternate one of the plurality of playout servers is currently playing out digital content or is scheduled to play out digital content before a completion would occur of a playing out of an interrupted digital content at the alternate one of the plurality of facilities.

11. The system of claim 1, wherein interrupted digital content is written to a respective storage device coupled to a respective one of the plurality of playout servers of an alternate one of the plurality of facilities, if not already stored therein, to provide local subsequent playing out of the interrupted digital content at the alternate one of the plurality of facilities and minimize network bandwidth consumption.

12. A method in a digital cinema theater, comprising the steps of:
providing a plurality of playout servers coupled with a central storage server, each of the playout servers and the central storage server having a respective local storage device for redundantly storing digital content, each of the playout servers being capable of playing out a scheduled one of the digital content to a respective local one of the plurality of facilities from a respective local storage device of one of the plurality of playout servers and central storage server; and
selecting a source for digital content playout for a respective one of the plurality of playout servers to permit different digital content playout for at least at one of the plurality of facilities.

13. The method of claim 12, wherein the selecting step further comprises, the selection being made from among the local central storage device and the respective local storage device of each of the plurality of playout servers, and being based upon at least a current playing out ability of a scheduled one of the plurality of playout servers, and a playout schedule of the respective local storage device of the respective one of the plurality of playout servers at one of the plurality of facilities.

14. The method of claim 12, wherein the selecting step is performed so as to initially select a respective local storage device of a respective one of the plurality of playout servers at one of the plurality of facilities, when a playout schedule thereof is not affected thereby.

15. The method of claim 12, wherein the selecting step comprises automatically identifying if one or more of the plurality of playout servers has been affected by a malfunction, and which digital content was interrupted when playing out on a scheduled one of the plurality of playout servers.

16. The method of claim 12, wherein the selecting step excludes a respective local storage device coupled to a scheduled one of the plurality of playout servers, when the respective local storage device coupled to the scheduled one of the plurality of playout servers is unable to play back digital content.

17. The method of claim 12, wherein the selecting step excludes a respective storage device coupled to an alternate one of the plurality of playout servers, when the alternate one of the plurality of playout servers is currently playing out digital content or is scheduled to play out digital content before a completion would occur of a playing out of digital content at one of the plurality of facilities.

18. The method of claim 12, further comprising writing digital content to a respective storage device coupled to a respective one of the plurality of playout servers of one of the plurality of facilities, if not already stored therein, to provide local subsequent playing out of digital content at one of the plurality of facilities and minimize network bandwidth consumption.

19. The method of claim 12, further comprising determining one of how much digital content has been played prior to a malfunction or remains to be played subsequent to a malfunction, wherein said determining step comprises the steps of sending requests to the central storage server, or by making the same requests of a scheduled one of the plurality of playout servers when scheduled ones of the plurality of playout servers are still functional.

20. The method of claim 12, further comprising switching a respective one of the plurality of playout servers at one of the plurality of facilities from scheduled operations to a malfunction recovery mode, wherein the switching step is performed either at the central storage server or at the respective one of the plurality of playout servers at one of the plurality of facilities.

21. A playout control system for a digital cinema theater, comprising:
a plurality of playout servers, each configured to playout digital content at a respective one of a plurality of facilities and having a respective local storage device configured to store the digital content; and
an selection module, for selecting a source for playing out in an alternate one of the plurality of facilities in place of a scheduled one of the plurality of facilities from a respective one of the plurality of playout servers in place of a scheduled one of the plurality of playout servers a portion of a digital content interrupted by a malfunction occurring at the scheduled one of the plurality of facilities, the selection being made from among the respective local storage device of each of the plurality of playout servers, and being based upon at least a current playing out ability of the scheduled one of the plurality of playout servers, and a playout schedule of the respective local storage device of the respective one of the plurality of playout servers at the alternate one of the plurality of facilities.

22. The system of claim 21, wherein the selection module is configured to perform the selection so as to initially select the respective local storage device of the respective one of the plurality of playout servers at the alternate one of the plurality of facilities, when the playout schedule thereof is not affected thereby.

23. The system of claim 21, wherein at least one the plurality of playout servers is further configured to receive the digital content from a remote distribution source.

24. The system of claim 21, wherein at least one of the plurality of playout servers is further configured to assign particular movies to the plurality of facilities, and schedule playout times for each of the plurality of facilities.

25. The system of claim 21, wherein at least one of the plurality of playout servers is further configured to decrypt and decompress digital content media tracks, and receive and re-distribute keys from a remote movie distribution source, the keys for decrypting the digital content.

26. The system of claim 21, wherein each of the plurality of facilities comprises a respective display screen, and the malfunction relates to one of, the respective one of the plurality of playout servers, the respective local storage device, and the respective display screen, of the scheduled one of the plurality of facilities, and an undesirable condition itself of the scheduled facilities.

27. The system of claim 21, wherein the selection module is configured to perform the selection so as to exclude the respective local storage device coupled to the scheduled one of the plurality of playout servers, when the respective local storage device coupled to the scheduled one of the plurality of playout servers is unable to playback the interrupted digital content.

28. The system of claim 21, wherein the selection module is configured to perform the selection so as to exclude the respective local storage device coupled to the alternate one of the plurality of playout servers, when the alternate one of the plurality of playout servers is currently playing out digital content or is scheduled to play out digital content before a completion would occur of a playing out of the interrupted digital content at the alternate one of the plurality of facilities.

29. The system of claim 21, wherein the interrupted digital content is written to the respective storage device coupled to the respective one of the plurality of playout servers of the alternate one of the plurality of facilities, if not already stored therein, to provide local subsequent playing out of the interrupted digital content at the alternate one of the plurality of facilities and minimize network bandwidth consumption.
